(19) United States
(12) Patent Application Publication
(10) Pub. No.: US 2019/0139051 A1
(43) Pub. Date: May 9, 2019

(54) BIOMETRIC SECURE TRANSACTION SYSTEM

(71) Applicant: Kenneth A. Kopf, Greensboro, NC (US)

(72) Inventor: Kenneth A. Kopf, Greensboro, NC (US)

(21) Appl. No.: 15/987,832

(22) Filed: May 23, 2018

Related U.S. Application Data
(60) Provisional application No. 62/510,007, filed on May 23, 2017.

(51) Int. Cl. G06Q 20/40; G06F 21/32; H04L 9/32; G06Q 20/38

(52) U.S. Cl. CPC G06Q 20/40145; G06F 21/32; G06Q 2220/00; G06Q 20/385; H04L 9/3231

(57) ABSTRACT

A system and method for authenticating and implementing secured transactions using biometrics: A registrant, registers his/her fingerprint within a single-point of entrance dual repository system and each registrant is assigned a separate secure identifying number which will be then be utilized by an end user to identify and associate the account. Biometrics are used authenticate the transaction which can be a financial or non-financial transaction.

### CROSS-REFERENCE TO RELATED APPLICATION

This application claims the benefit under 35 U.S.C. § 119(e) of the earlier filing date of U.S. Provisional Application No. 62/510,007 filed on May 23, 2017, the disclosure of which is incorporated by reference herein.

### BACKGROUND

Crimes such as data breaches, credit card and debit card fraud, cell phone hacking and identity theft are increasing and are a significant problem in the commercial sector as well as for governments. There is thus a need for a method and system for reducing commercial and government “payment card” fraud, identity theft and other forms of data breach.

Current U.S. military and federal security operations are actively utilizing biometrics across all agencies and applications—especially in the areas of military security, border protection and immigration control, terrorism prevention and forensics, as well as criminal analysis. The programs utilize fingerprint technology, as well as voice analysis, facial recognition, DNA, and advanced biologic technologies. Government acceptance of fingerprint technology for conclusive identification has been established and is being accepted as an important part of the government's multi-modal system.

Currently card issuers (and users) employ one of the following “in person” methodologies: “swipe” (magnetic stripes); “near field technology” or “chip and pin”. For on-line purchases, card data is entered via digital transactions. Notwithstanding implementation of certain security approaches, all of these methodologies are considered vulnerable to hacking, theft or impersonation and have not significantly reduced fraud or identity theft. One of the most recent approaches, has been “Apple Pay” utilizing Apple's iPhone RF near-field technology. While Apple utilizes the user's fingerprint, that only activates the internal phone process. The process can also be activated by the user's PIN, and Apple watch can only be activated that way. The user's fingerprint is not associated with the user's card data and cannot conclusive authenticate that the card holder made the transaction. Technologies such as “Apple Pay” utilize combined (unrelated) functions and technologies to be able to transact digital payments via RF signals (Bluetooth or similar technology) to another recipient—POS machine or other equipment (such as in “Bump” functionalities). In these methodologies user card data is resident in the phone and is accessed and transmitted utilizing the phone itself as the “near field” transmitter as opposed to using the credit/debit card itself. This technology then is also utilized for on-line payments or purchases—instead of manually entering the required card data.

In addition to the above types of “resident” equipment (cards and phones where user data is stored), the on-line internet world is utilizing various methodologies to conduct purchases and financial transactions. These include, PayPal, Venmo, American Express and other Payment Apps (“Serve”, Pingit, ISIS), Barclay's “PayTag” (tag adhered to back of mobile phones), Wrist Bands (“PayBand”) with embedded data, etc. where users tie their ‘payment systems’ (cards, accounts) to this intermediary payment system.

The current payment technologies have the following drawbacks related to convenience and security, which the disclosed method and system are designed to eliminate:
a) Card use—must utilize the card in the transaction. Risk of a lost card or data/personally identifiable information (“PII”) hacking or “interception” before or during use; card replacement with new account number.
b) Radio Frequency (“RF”) (and related electronic payment methods)—PII/account data is still resident in the “unit” subject to hacking, theft and misuse; lost unit precludes use and allows for possible identity theft; data transmitted unencrypted to POS; usage/purchase data resident in the system (such as Apple Pay) increasing lack of personal privacy; PII/account data transmitted unencrypted from POS subject to “intermediary” interception/hacking.
c) PC/Laptop based payment methods (interne based payments)—data is resident in the computer making it subject to hacking/interception; computer lost/stolen thus lost PII/data; computer corrupted or damaged thus not usable; data may not be encrypted or not transmitted securely; relying on vendor site for security.

There is thus a need for an improved method and system for authenticating and implementing secured transactions be they financial, data-based or identity-based.

There is also a need for an improved method and system for authenticating and implementing secured transactions outside financial use. The term “transactions” in this application is used to refer to both financial and non-financial transactions.

There is also a need for an improved method and system for vehicle authentication to activate the vehicle ignition without using a key.

There is also a need for a secure transaction system that does not require or rely on any additional tokens or devices that are stored or used, all of which are subject to being hacked, intercepted, stolen and typically utilized in ID theft/fraud.

### SUMMARY

The disclosed method and system is directed to a method and system for authenticating and implementing secured transactions using biometrics as a service. Various embodiments disclosed herein, a method and system which is an out-of-band tokenless biometric system utilized in environments where secure, conclusive and authenticated identity is necessary or required. In the various embodiments, the biometrics utilized may include, for example, fingerprints, hand prints, face print, voice prints, retinal images or other uniquely identifying characteristics.

Various embodiments combine the use of biometric (fingerprint) technology augmented with multi-modal security technology to create a process which: (1) significantly reduces or eliminates the ability or opportunity to commit credit/debit card fraud; (2) helps reduce or eliminate identity theft; (3) provides a secure, conclusive transaction authentication system; and (4) provides a robust, scalable system that can be adapted to multi-applications and platforms (including “open” environment systems such as commercial retail services; “closed” environment systems with limited participants; and government services). The disclosed method and system will require no change in process or require any capital expenditure for the end user (card issuer).

Various embodiments utilize a multi-modality security system with encryption and authentication techniques to ensure that the system is internally and externally secure, and personally identifiable information (“PII”) is not disclosed in the merchant purchase process or identity verification process. The card user, or other registrant, registers his/her fingerprint within a single-point of entrance dual repository system and each registrant is assigned a separate secure identifying number (SIN) which will be then be utilized to identify and associate the card issuer end-user, or other non-financial end-user, to the registrant's credit/debit card or non-financial account. The registrant can then simply utilize only a fingerprint for any “point of sale” transaction or other non-financial transaction. Various embodiments utilize dual repositories with redundant fail-over capability. The first repository contains the registrants' biometric sample. The second repository contains the registrants' individually identified SIN and non-PII data. Both are secured by the military-grade “guards”. Various embodiments uses Point-of-Sale (“POS”) hardware as well as modular units (“thin clients”) for individual registration with the system. The disclosed method and system is capable of being utilized in any financial transaction utilizing a credit/debit card or in other types of transactions where positive individual identification is required. The disclosed method and system can also operate without modification within various non-financial multi-platform environments and applications such as an educational, medical and patient identity control and real estate transactions—to securely control and authenticate all transactions. The disclosed method and system can also be used for vehicle authentication for to activate the vehicle ignition without using a key or other apparatus or token.

### BRIEF DESCRIPTION OF THE DRAWINGS

Various embodiments of the invention are described herein in by way of example in conjunction with the following figures, wherein like reference characters designate the same or similar elements

FIG. 1 is a schematic view showing user registration.

FIG. 2 is a schematic view showing user transaction.

FIG. 3 is a schematic view showing security.

FIG. 4 is a flow diagram showing process flow.

FIG. 5 is a flow diagram showing an in-store process.

FIG. 6 is a flow diagram showing a remote computer process.

FIG. 7 is a flow diagram showing a vehicle activation process.

FIG. 8 illustrates a flowchart for tokenless authorization of a transaction according to an exemplary embodiment.

FIG. 9 illustrates an exemplary computing environment that can be used to carry out and implement the methods described herein.

### DETAILED DESCRIPTION OF THE INVENTION

Disclosed herein is a method and system which provides a multi-application, military standard, secure, biometric based payment and identification (ID) authentication transaction system. The system links consumers, retailers and financial institutions by providing them with a multi-tiered secure credit/debit card transaction platform, and also reduces the current levels of credit/debit card fraud and identity theft. In the various embodiments, the biometrics utilized may include, for example, fingerprints, hand prints, voice prints, retinal images or other uniquely identifying characteristics.

The method and system can be used for both financial and non-financial transactions. Various embodiments are disclosed below.

In a first disclosed embodiment, in an effort to curb the fraud associated with the use of credit/debit cards and associated client data, the method and system eliminates the use of a physical card or other token, and utilizes biometrics which is a uniquely identifiable, secure authentication system. In the disclosed method and system of this embodiment, the biometrics used are fingerprints. The disclosed method and system eliminates the possibility of personally identifiable information (“PII”) theft, whether it occurs at the point-of-sale (“POS”), from loss of a storage unit such as a personal computer (PC), laptop, mobile phone, from hacking, or from a physical card loss—thereby, significantly reducing the possibility of and incidents of fraud. The method and system can be used without the necessity of even using or possessing a physical card or other apparatus such as a mobile phone. The system incorporates and maximizes state-of-the-art multimodal technology, including contactless fingerprint capture. The system utilizes a multimodality security system with encryption, out-of-band tokenization authentication techniques (transaction-specific security), and data guards to ensure that the system and the customers' PII is not disclosed during the merchant purchase process. Registrant account information is registered and verified by the card issuing entity and then is maintained encrypted in two separate, but co-located repositories (with redundant systems for fail-over) protected by secure guards with a single point of entry. The unique POS system eliminates the possibility of theft or other fraudulent intrusion at this link and utilizes secure transmission of data from the POS to the account information data storage further reducing the possibility of obtaining any registrants' account information, even in the instance of any hacking. The system also incorporates a PC-based unique local system to register a registrant's card into the system, utilizing the same secure technologies, thus, eliminating current insecure PII PC-based storage and transmission methods.

Embodiments of the disclosed e method and system eliminate the need for any card issuer to alter its physical cards, methods of issuance, or processing payments. Thus, there is no requirement for capital expenditures on their part. The process and system adds two significant layers of additional security protection for all parties—registrants, retailers and card issuers:
encryption of card data (fingerprints and account data) at registration and via the POS;
separate data repositories for each of fingerprints and account data with a single point of entry;
data repository security “guards” to prevent hacking, interception and infiltration;
predictive analytics and “challenges” for registrant security and positive registrant authentication.

The use of fingerprints reduces operational costs for account issuers (for theft, fraud, card re-issuance, technology refresh, CAPEX for hardware replacement and improvement, etc.), eliminates the need for PINs or other token verification processes, and serves as conclusive registrant authorization. A potentially significant use of the method and system is by governments in distribution of all forms of public financial assistance payments, or other cash payments to beneficiaries or other government recipients, to reduce fraudulent use of the current payment card system (e.g., the system can track who uses the assigned funds, and can eliminate the recipient's improper use or sale of the cards, etc.).

The method and system can be used for individual consumer credit and debit card users, credit and/or debit card issuers, (whether a financial institution or retail proprietary cards), and governments who utilize card-based or other payment systems. The method and system can be utilized, without change, in other government applications where fraud and ID security are critical, such as: passport and immigration control; Medicare/Medicaid authorization; IRS and Social Security authentication; student loans; voting and voter registration.

In a non-government market, the method and system can be used for secure vehicle authentication to start a vehicle. These uses have common elements and security issues which the disclosed method and system are intended to address, namely:

Large numbers of electronic payment cards in circulation;

Wide-spread fraud, misuse, and security issues related to the issuance and use of the cards;

Significant costs incurred annually by users, card issuers (financial institutions and retailers) and the national economy as a result of the above issues;

Lack of systematic security which incorporates newest technological protections and therefore contributes to increased “loss”;

A national economic system which is intent on becoming a “cashless” society;

An increasing number of incidents of major security breaches and attacks on “electronic payment cards”, card issuers, entities who maintain and issue those cards, and other entities who possess individuals' PII.

Significant and wide-spread fraudulent registration and utilization of government benefits which cause major financial losses, waste of federal and state revenue expenditures and create national security threats.

The transaction processing time for the disclosed method and system is configured such that it will not exceed current competitive system processing times. Transaction accuracy will meet or exceed current competitive standards. The system components are built and operate to U.S. military and banking standards and industry privacy standards.

The currently disclosed method and system is configured to meet U.S. government and industry standards. Mil Standard encryption, predictive analytics and data guards are used in the disclosed system and method. The system and method are designed and configured with encryption, fingerprint reader hardware, fingerprint recognition algorithms, and predictive analytics.

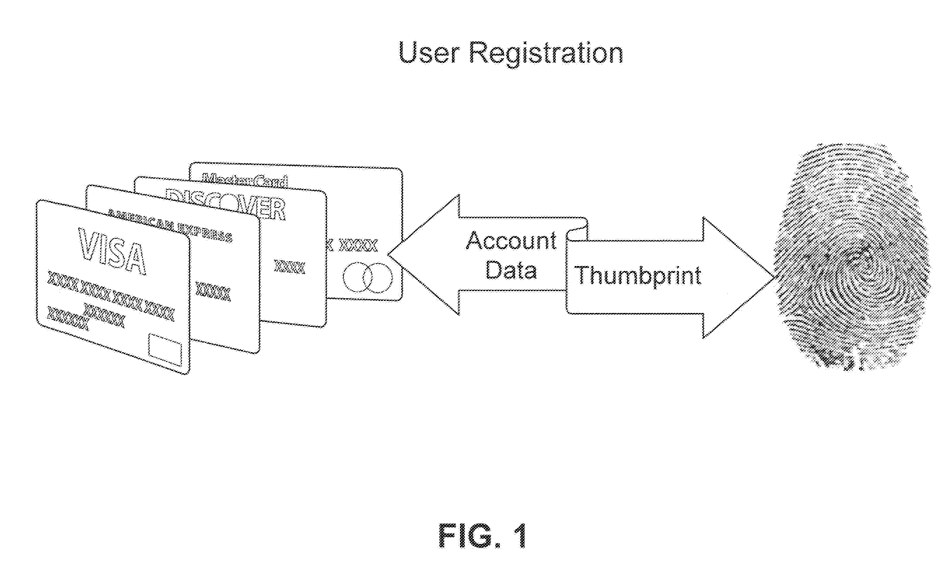

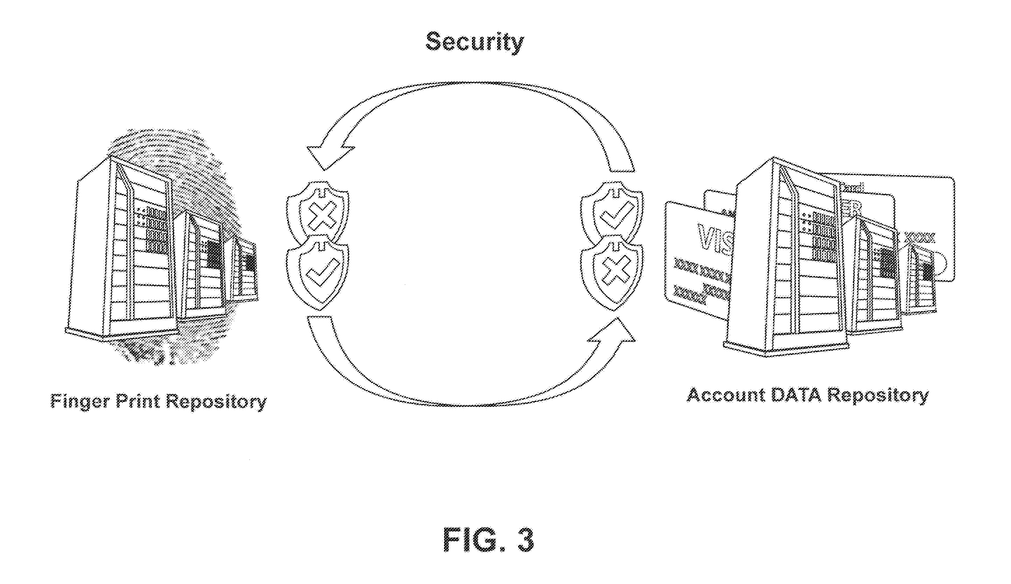

Other aspects of the method and system are disclosed in FIGS. 1 through 7 included herewith.

Referring to FIG. 1, a registrant registers to the system by providing account data and biometric data such as fingerprint data. The fingerprint data is provided using a fingerprint reader. Account data may be provided by card utilization methods such as: swipe (magnetic stripes); near field technology or chip and pin, or the account data may be entered digitally. For example, a modular (plug-and-play) unit can be utilized by the card holder to register his/her cards with the system in the privacy of his/her home. The unit contains the operating system and a fingerprint reader which allows the registrant to register their fingerprint data and their credit/debit cards into the system. This modular unit can then serve as the method of on-line payments for internet purchases. The modular unit can also be replaced with a key fob or thumb drive so that the registrant can carry with him/her the ability to make internet-based payments via the system instead of using a physical credit card. The fingerprint data is sent from the unit to a finger print repository using encryption. The account data is sent from the unit to a separate account data repository using encryption. Preferably, fingerprint data from more than one fingers are collected. For example, fingerprint data from four different fingers are collected. Fingerprint data may also be collected from a pre-selected finger for emergency alarm purposes such that when the pre-selected finger is read by the system's finger print reader, an alarm is forward to authorities Fingerprint data is translated by the system into a template storage format, thus not only preserving accuracy but also reducing data size. Specifically, the minutiae from a fingerprint are extracted by a software algorithm; images from the fingerprint reader are extracted into templates. These templates are data structures created by an algorithm that map the minutiae and patterns in relation to the center of the fingerprint. The resulting map is a set of coordinates that can be searched using matching algorithms.

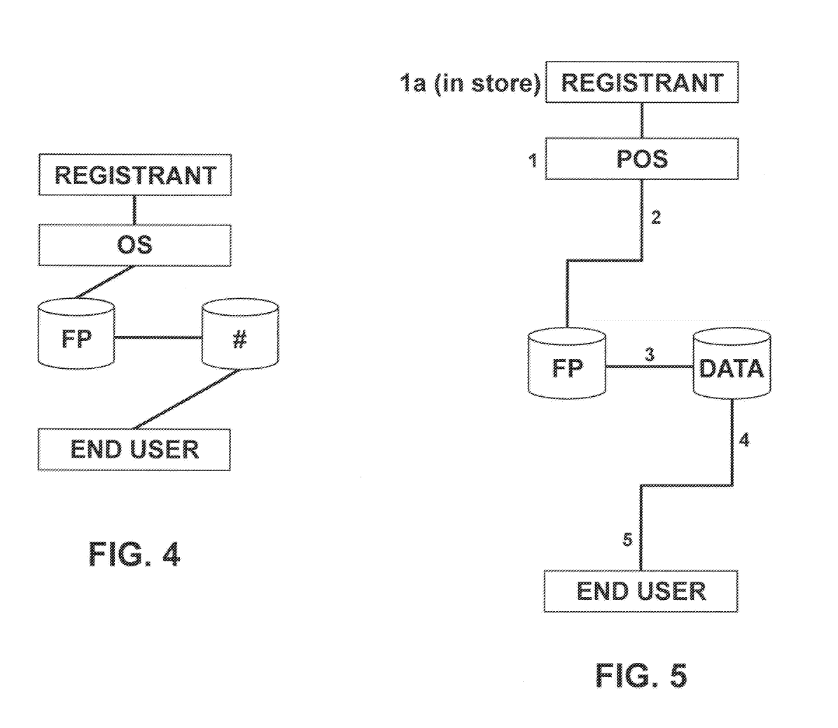

Referring to FIG. 4, each registrant is assigned a separate secure identification number which is then associated with both the registrant's fingerprint data and with the account data. The secure identification number is attached to the registrant's file in the card issuer's database. No fingerprint data or account data remains in the registrant's computer or modular unit in this registration process, which eliminates the possibility of identity theft due to hacking, lost computer, etc.

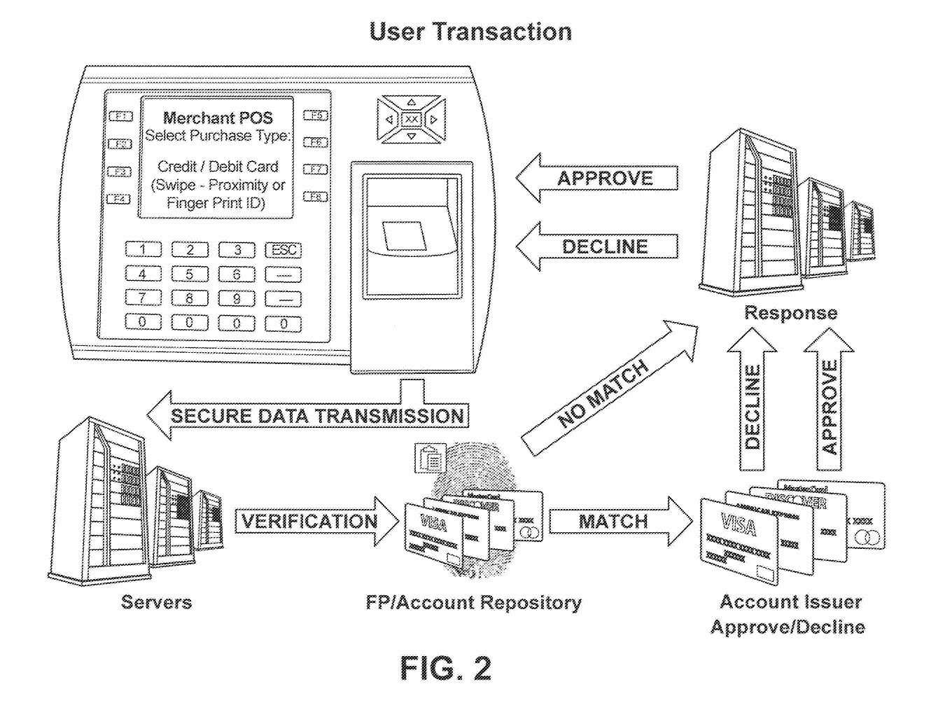

Referring to FIG. 2, a point of service (POS) unit retains card utilization such swipe, RF near field, chip and pin capabilities, and also includes a fingerprint reader. The operating system (OS) is resident in the POS hardware which contains encryption software to transmit the fingerprint at the time of retail purchase.

Referring to FIGS. 1-3, a registrant engages the operating system (OS) via a unit such as a modular unit to engage a two-step registration process. Using the fingerprint reader on the unit, fingerprint data is collected. The fingerprint data is encrypted and sent to the fingerprint data repository. The fingerprint data is decrypted and verified as accurate according to known standards. Once the fingerprint data is accepted then, the registrant enters account data including card and personal data into the modular unit which is then associated with the fingerprint data. The account data is also encrypted and sent to the account data repository. A secure identification number (SIN) is assigned to link a registrant's card data to a registrant's fingerprint data and stored at the account data repository. The linking of the SIN to both the fingerprint data and the card holder data can be performed, for example, by transmitting a unique identifier derived from the fingerprint data to the account data repository along with the account data (card holder account information), which then assigns the SIN to the account data and links the SIN with the unique identifier derived from the fingerprint data. The actual linking of the SIN with the account data and the fingerprint data can be performed in a variety of ways. For example, a unique identifier derived from the fingerprint data can be mapped to one or more account data records, which are themselves mapped to one or more SINs. The secure identification number is sent to the card issuer to link the secure identification number to card holder account data.

Referring to FIG. 5, for an in-store retail purchase, 1) a registrant engages a fingerprint reader on a point of service unit to read the registrant's fingerprint. 2) The fingerprint data is encrypted and sent to the fingerprint data repository. The fingerprint data is decrypted and matched. If the match is good, then sent to account data repository. If the match is not good, an alternate fingerprint is taken, or the registrant is prompted to use another method. 3) If the fingerprint data is a good read, then the fingerprint data is matched to the account data in the account data repository. For example, as discussed earlier, a unique identifier can be derived from the fingerprint data using the same process used during registration to link the account data and fingerprint data and assign a SIN, and this unique identifier can be used to determine if there are any matching account data records for that unique identifier. If more than account is registered to that biometric sample, the registrant is prompted to choose the type of card. 4) If there is a match between the fingerprint data and the account data, transaction data and the secure identification number corresponding to the account data (or corresponding to selected account data when there are more than one matching account data records) are sent from the account data repository to the card issuer. 5) The card issuer matches the secure identification number to the registrant's account and approves/rejects transaction.

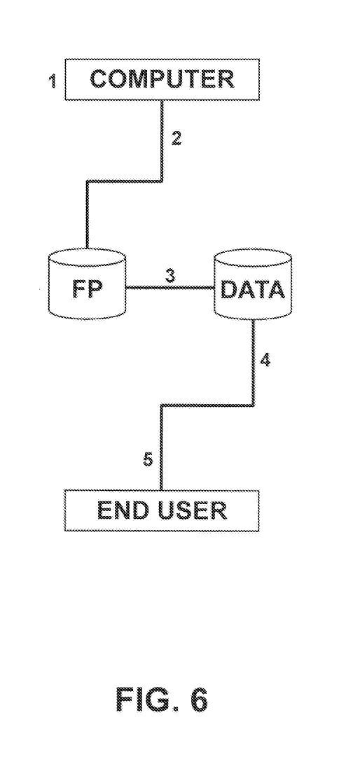

Referring to FIG. 6, for a remote computer or PC purchase, 1) a registrant engages a fingerprint reader on a modular unit containing the operating system and encryption software (the fingerprint reader may also be on the keyboard). 2) The registrant makes a purchase on a website, goes to cart on website to pay, clicks pay and activates fingerprint reader on the modular unit to make a payment. Steps 3) to 5) are same as those described with relation to FIG. 5.

In another embodiment, the method and system can also be used within a non-commercial multi-platform “closed-system”—such as an educational institution environment—to securely control and authenticate all student transactions. The method and system are the same as that shown in FIGS. 1-6, with the substitution of identification (ID) for account information. The method and system for both financial and non-financial transactions are discussed in more detail below.

The method is a tokenless out-of-band individual identity confirmation and security system whereby individuals register their identity with an out-of-band digital repository by registering multiple biometric samples, which initial registration identity is based on.

Out-of-system verification of authorized registrants is confirmed by non-biometric data provided by individual registrants to system end-user.

Out-of-band digital repository system contains no individual PII or other fraudulent-capable individual identifying data other than biometric samples and non-identifiable end-user matching data.

During registration, the participant registers within the system utilizing a registration unit having a biometrics reader associated thereto by submitting multiple biometric samples using the system's stand-alone biometric capture hardware tied directly to a repository system including two separate, out-of-band secure repositories. The system is capable of capturing and analyzing biometric samples individually and in multiples including one specific identified biometric sample to be utilized solely for critical or special purposes. Biometric samples are captured by the biometrics reader and are also translated into template storage format using encryption to ensure secure transmission capability to the repository.

The encrypted biometric data is sent to a first repository of the repository system. The first repository then decrypts the submitted biometric data.

During the registration step, account information is also entered or captured utilizing the registration unit which encrypts the account information and sends it to the first repository. The first repository then decrypts the submitted account information data.

Upon completion of the registration of multiple biometric samples, the first repository generates a digital secure identification number (SIN) utilizing quantum random number generation. This SIN is linked to the first repository's biometric samples and utilized internally, only, to compare and validate the biometric sample to the registered account of the end-user. During registration, this SIN is provided by the system to the identified card/account issuer for linking to the identified account.

The SIN and the decrypted account information are sent to a second repository from the first repository, wherein the SIN is stored in the second repository.

The SIN and the decrypted account information are also sent to an end user from the second repository so that the end user can link the SIN and the account information.

During a transaction, the only account data that is transmitted is the SIN and TDI (transaction data information). Registrant entrance into and use of the identify verification system requires only a biometric sample and no other token or apparatus.

Specifically, during the transaction, at least one biometric sample of the registrant is captured by a second biometric sample reader associated with a transaction unit to create second biometric data. The second biometric data is encrypted and electronically sent from the transaction unit to the first repository where the first repository decrypts the encrypted second biometric data.

The first repository compares the decrypted second biometric data to the decrypted first biometric data and determines whether there is a match between the first biometric data and the second biometric data. The transaction data information is encrypted and sent from the transaction unit to the first repository. If a match between the first biometric data and the second biometric data is determined, the transaction data information is electronically sent to the second repository from the first repository. After comparison of SIN, the transaction data information and the secure identification number linked to the first biometric data are electronically is then sent to the end user from the second repository.

The end user then determines approval or disapproval of the transaction for the transaction data information sent from the second repository and the registrant's account linked to the secure identification number sent from the second repository and sends the approval or disapproval to the transaction unit through the first repository. Specifically, after confirmation of biometric sample and comparison of SIN, the second repository translates the unique and individual transaction into a reporting system unique to the end-user requiring verification and identification.

The second repository, if a financial transaction is applicable, will generate, via the point-of-sale unit, a TDI which will be sent by the second repository directly to the end-user, in some cases a payor or in other cases a reporting entity, for accounting, payment or other financial tracking.

The system is utilized for any purpose of the end-user and registrant necessary or required to ensure and confirm individual identity to include secure entrance to facilities, programs or other controlled access operations; secure transactions, financial and non-financial, where asset tracking is required or where financial related transactions are initiated; operations and events that require secure and confirmed individual identification as a requirement for participation; utilization of individual control to eliminate asset or financial fraud.

The digital repository operates such that individual identity is confirmed via out-of-band analysis and is agnostic to type of end-user by utilization of assigned quantum generated random SIN matching to biometric sample. SIN is unknown to or used by individual assigned that SIN and eliminates the need for any token or any other apparatus to compare or further identify the individual.

Once confirmed, the second repository then processes the identified transaction, whether it is simple verification of identity, a necessary financial transaction between participant and an end-user, or some other form of end-user-registrant individual confirmation transaction.

Digital repository and transaction verification system is capable to be utilized in a remote capacity, individual from a static system of readers, point-of-sales units or facilities or other static-based operations, and is operated without need for or reliance on any apparatus or token. For example, the system may be used with remote readers for registrant and/or end user events, such as, student attendance, sponsored activities, document and asset control, etc. as well as for use with roving POS for retail financial transactions for restaurants, etc.

The disclosed system also includes, within the comparison process, a system of digital challenges and a layer of predictive analytics triggered dependent on biometric usage, purpose of usage and random. The digital challenges are secondary verifications initiated by the first repository and sent to the transaction unit. The digital challenge may be, for example, a request to recapture biometrics data if the captured biometrics data is not readable. For example, the registrant may be asked to use a different finger to capture a fingerprint. Digital challenges, such as predetermined questions, may also be issued randomly as an additional security process.

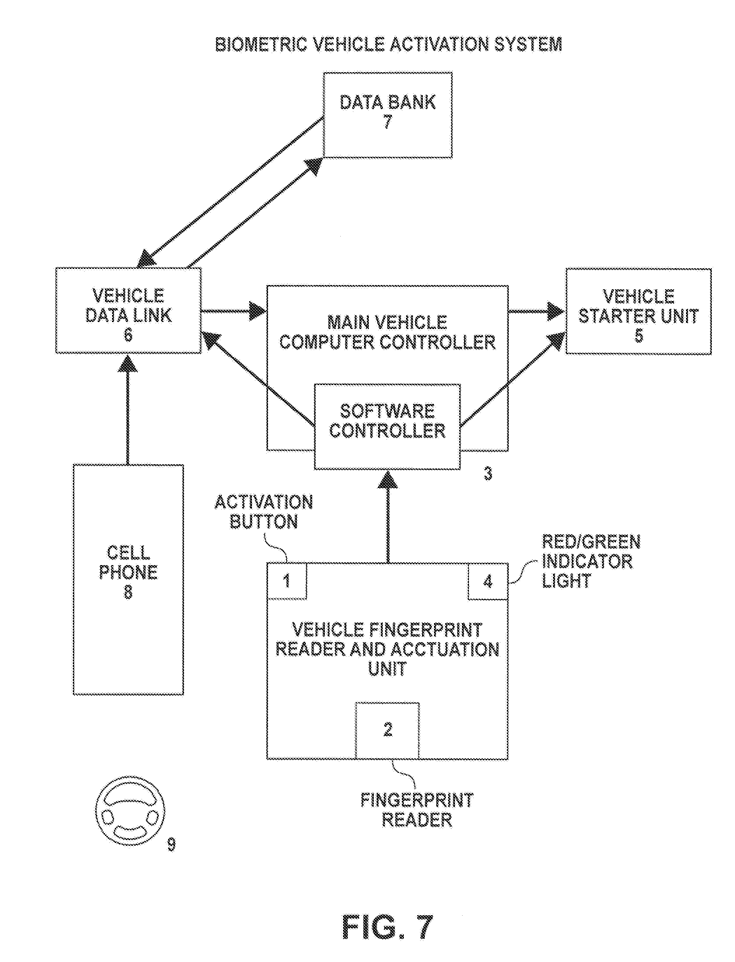

As shown in FIG. 7, for example, the method and system can also be used as a method and system for secure vehicle ignition control. One preferred method includes:
1) Push button activates fingerprint integrated unit and allows fingerprint reader utilization/recognition and activation of vehicle starter method.
2) Once the fingerprint unit is activated, a registered vehicle operator places his/her finger on the reader. The fingerprint reader captures operator's fingerprint, and is encrypted and sent to the internal computer processing unit, which is embedded in the vehicle's main computer center. The fingerprint reader unit additionally serves as the unit for the vehicle owner(s) to register their fingerprint with the system's CPU and the system's external data bank. Under this method, the owner can choose whether to operate the vehicle as “Fingerprint only” or as “Fingerprint or Key”.
3) The system's embedded computer processing unit decrypts and matches the fingerprint against all vehicle registered fingerprints. The fingerprint is either accepted or rejected.
4) Once the system's CPU receives, decrypts, matches and authorizes the vehicle operator's fingerprint, it activates the fingerprint reader's green light visually indicating acceptance. If an error occurs in the process, a red light will be activated indicating and error and need to restart the process, or use a vehicle key.
5) If the system's CPU accepts the fingerprint, an electronic signal is sent to the vehicle starter unit to start the vehicle's engine.
6) If the system's CPU accepts the fingerprint, it is sent, via the vehicle's on-board wireless data link to the external system's computer data bank center and is registered as “in operation”.
7) As a security protective method, the vehicle owner can utilize the system's computer data bank center to send a signal to the vehicle to “kill the engine”, and as record of vehicle usage.
8) Use of cell phone as an adjunct for vehicle operation.
   a) Vehicle owner/operator can register his/her fingerprint into the system's external software data bank center via either the vehicle fingerprint reader (see 2) above) or via the system's external methodology.
   b) Utilizing the cellular telephone or a computer to access the system's Internet website connected to the system's external software data base center, the owner/operator will:
      Activate the system's fingerprint reader;
      Placing the fingerprint on the reader
      The reader encrypts the fingerprint and sends it to the system's data bank center;
      The fingerprint is received, decrypted, matched and authorized (or rejected);
      If the fingerprint is accepted, the owner/operator can:
      a) Via the system's data bank center send a wireless signal to the registered vehicle internal data link (6);
      b) The data link will send the signal to the vehicle's internal system's CPU (3);
      c) The system's CPU will send the signal to the vehicle's starter unit (5)
      d) The vehicle will start.

If the Fingerprint is accepted by the system's data bank center (7), the owner/operator can:

a) Send a wireless signal the registered vehicle internal data link (6);

b) The data link will send a signal to the vehicle's internal system's CPU (3);

c) The system's CPU will send a signal to the vehicle's starter unit (5)

d) The vehicle will shut off

9) The vehicle steering wheel surface contains an electro-sensitive strip of conductive materials which will record and transmit the operator's fingerprint(s) via the steps stated in 3) through 6) above.

The disclosed method and system have several advantages over known methods and systems. Regarding credit/debit cards, the disclosed method and system have the advantages of no card ever needed—no replacements, no inconvenience, no need to ever change account number; uses fingerprint as conclusive ID and authentication; can be used for multi-applications and multi-platforms—not just financial transactions; utilizes multi-modal out-of-band security methods. Credit/debit cards, on the other hand, can be lost/stolen, hacked, worn out, must then be replaced, account number changed, must have card to use, can only be used for financial transactions, security limited to PIN, delays and inability to use during waiting for new cards, higher risk of identity theft, accounts can be fraudulently established in other's name using PII.

Regarding digital transmissions, the disclosed method and system have the advantages of no physical apparatus needed, fingerprints are primary security control and are linked to issuer's system, so if account changes, no need for additional action, fingerprints can only be used by one person; no transaction data is stored in system; user's data not used for any other purpose each card can be registered in system with any number of users; theft of card data cannot be used by thief; system uses additional security; cannot hack or use fingerprint remotely by thief; operating system resides outside of user's computer and any intermediate's computer and utilizes encryption while entering card data and fingerprint to be transmitted, reducing or eliminating possible interception/theft; use of card secure identifier number (“SIN”—tagged to fingerprint and account information) and encryption and “challenges” (multi-modality).

Digital RFID transmissions have disadvantages, such as, the individual must use a physical apparatus to conduct the transaction; cannot use the system if the apparatus is lost or inoperable; can be activated by apparatus code which can be stolen/hacked; such use is not conclusive evidence of the user's identity; transaction data is collected on registration and can be used for marketing/other purposes; multiple users of single credit/debit card is not possible with single apparatus—requires multiple registrations on individual devices for single card; theft of card's data could allow thief to mirror or clone's user account via another apparatus; hacking attempts can be made remotely—at various points in the apparatus' transaction process via “sniffer” or other digital intercept methods; hacking and theft of card data at the issuer's server will still affect card holder's use via apparatus; card data can be intercepted or hacked while being entered into the phone and transmitted for registration; this process cannot be used on a PC for on-line purchases.

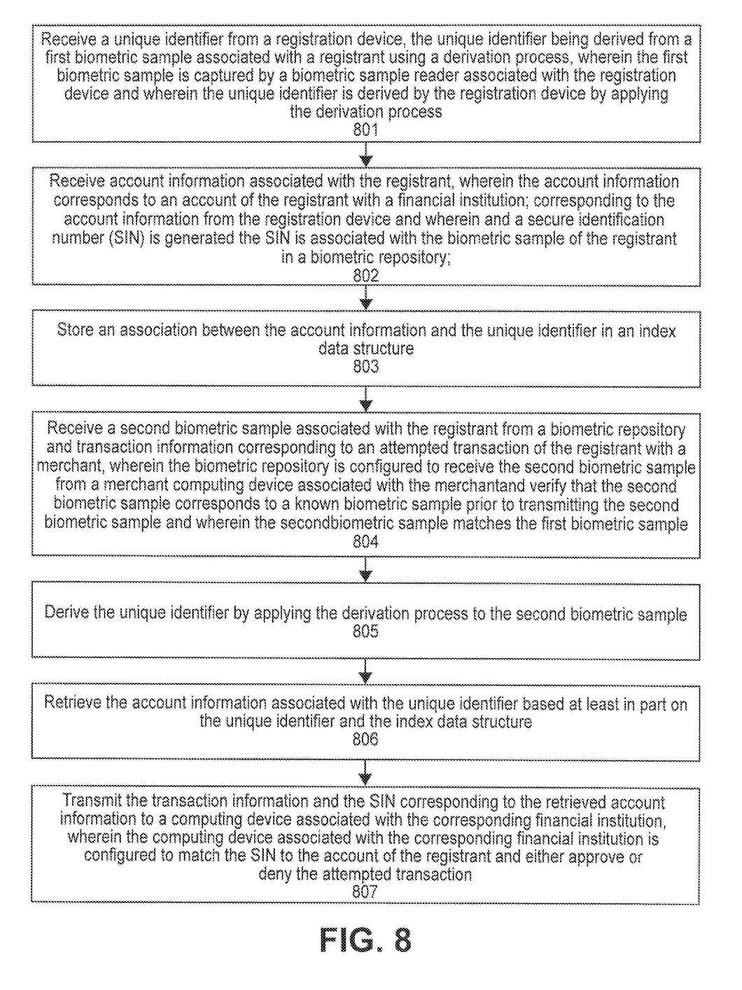

FIG. 8 illustrates a flowchart for tokenless authorization of a transaction according to an exemplary embodiment. The steps shown in FIG. 8 can be performed, for example, by an account data repository that stores the account information for a particular user, as discussed earlier. The steps can be performed in the context of a computer network that is responsible for authorization of an attempted transaction and can involve multiple components on the network. By storing fingerprint/biometric data at a different location within the computer network than account information and requiring verification of both biometric and account information prior to, the present system enhances operational security and minimizes risks due to data breach.

At step 801 a unique identifier is received from a registration device. The unique identifier can be derived from a first biometric sample associated with a registrant using a derivation process. The first biometric sample can be captured by a biometric sample reader associated with the registration device. Additionally, the unique identifier can be derived by the registration device by applying the derivation process.

At step 802 account information associated with the registrant is received from the registration device. The account information can correspond to an account of the registrant with a financial institution and the SIN can be associated with the biometric sample of the registrant in a biometric repository. This step can correspond to the process discussed earlier in which the registration device sends account information received from the user (such as via a card reader) to the account data repository. A secure identification number (SIN) is generated and associated with the biometric sample of the registrant in the biometric repository.

At step 803 an association between the account information and the unique identifier is stored in an index data structure. As additionally discussed earlier, this associated or link can be stored in a variety of ways. For example, a data structure can be generated or updated that links the account information and unique identifier values.

At step 804 a second biometric sample associated with the registrant is received from a biometric repository and transaction information corresponding to an attempted transaction of the registrant with a merchant is also received. The transaction information can be received from a point-of-sale device or a computing device associated with a merchant, or alternatively can be received from the biometric repository (which itself receives the transaction information from the merchant computing device. The biometric repository can be configured to receive the second biometric sample from a merchant computing device associated with the merchant and verify that the second biometric sample corresponds to a known biometric sample prior to transmitting the second biometric sample, as discussed earlier. Since the second biometric sample is from the same registrant (e.g., a fingerprint of the same finger from the same user), the second biometric sample matches the first biometric sample, where matching can assessed by the pattern recognition algorithms discussed earlier.

At step 805 the unique identifier is derived by applying the derivation process to the second biometric sample. The computing device(s) executing the steps shown in FIG. 8 (e.g., the account data repository) can store a copy of the derivation process used by the registration device in order to generate unique identifiers used to match biometric data to account data. Alternatively, the derivation process can be performed at the biometric repository and the resulting unique identifiers can be forwarded to the account data repository.

At step 806 the account information associated with the unique identifier is retrieved based at least in part on the unique identifier and the index data structure. This step can include, for example, querying the index data structure with the derived unique identifier, though many variations are possible.

At step 807 the transaction information and the SIN corresponding to the retrieved account information is transmitted to a computing device associated with the corresponding financial institution, such as the card issuer for a particular registrant. The computing device associated with the corresponding financial institution can be configured to match the SIN to the account of the registrant and either approve or deny the attempted transaction.

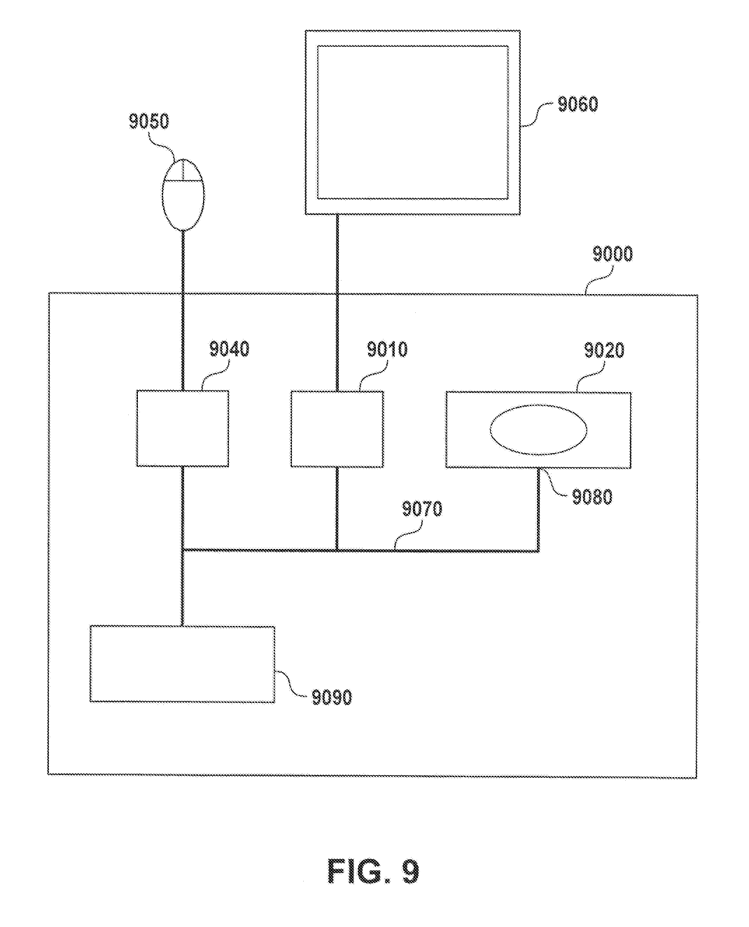

One or more of the above-described techniques can be implemented in or involve one or more special-purpose computer systems having computer-readable instructions loaded thereon that enable the computer system to implement the above-described techniques. FIG. 9 illustrates an example of a computing environment 900. The computing environment 900 is not intended to suggest any limitation as to scope of use or functionality of a described embodiment(s).

With reference to FIG. 9, the computing environment 9000 includes at least one processing unit 9010 and memory 9020. The processing unit 9010 executes computer-executable instructions and can be a real or a virtual processor. In a multi-processing system, multiple processing units execute computer-executable instructions to increase processing power. The memory 9020 can be volatile memory (e.g., registers, cache, RAM), non-volatile memory (e.g., ROM, EEPROM, flash memory, etc.), or some combination of the two. The memory 9020 can store software 9080 implementing described techniques.

A computing environment can have additional features. For example, the computing environment 9000 includes storage 9040, one or more input devices 9050, one or more output devices 9060, and one or more communication connections 9090. An interconnection mechanism 9070, such as a bus, controller, or network interconnects the components of the computing environment 9000. Typically, operating system software or firmware (not shown) provides an operating environment for other software executing in the computing environment 9000, and coordinates activities of the components of the computing environment 9000.

The storage 940 can be removable or non-removable, and includes magnetic disks, magnetic tapes or cassettes, CD-ROMs, CD-RWs, DVDs, or any other medium which can be used to store information and which can be accessed within the computing environment 9000. The storage 9040 can store instructions for the software 9080.

The input device(s) 9050 can be a touch input device such as a keyboard, mouse, pen, trackball, touch screen, or game controller, a voice input device, a scanning device, a digital camera, remote control, or another device that provides input to the computing environment 9000. The output device(s) 9060 can be a display, television, monitor, printer, speaker, or another device that provides output from the computing environment 9000.

The communication connection(s) 9090 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the context of computer-readable media. Computer-readable media are any available media that can be accessed within a computing environment. By way of example, and not limitation, within the computing environment 9000, computer-readable media include memory 9020, storage 9040, communication media, and combinations of any of the above.

Of course, FIG. 9 illustrates computing environment 9000, display device 9060, and input device 9050 as separate devices for ease of identification only. Computing environment 9000, display device 9060, and input device 9050 can be separate devices (e.g., a personal computer connected by wires to a monitor and mouse), can be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 9000 can be a set-top box, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

I/We claim:

1. A method executed by one or more computing devices for tokenless authorization of a transaction, the method comprising:
receiving, by at least one of the one or more computing devices, a unique identifier from a registration device, the unique identifier being derived from a first biometric sample associated with a registrant using a derivation process, wherein the first biometric sample is captured by a biometric sample reader associated with the registration device and wherein the unique identifier is derived by the registration device by applying the derivation process;
receiving, by at least one of the one or more computing devices, account information associated with the registrant, wherein the account information corresponds to an account of the registrant with an entity, and generating a secure identification number and wherein the SIN is associated with the biometric sample of the registrant in a biometric repository;
storing, by at least one of the one or more computing devices, an association between the account information and the unique identifier in an index data structure;
receiving, by at least one of the one or more computing devices, a second biometric sample associated with the registrant from a biometric repository and transaction information corresponding to an attempted transaction of the registrant with a merchant, wherein the biometric repository is configured to receive the second biometric sample from a merchant computing device associated with the merchant and verify that the second biometric sample corresponds to a known biometric sample prior to transmitting the second biometric sample and wherein the second biometric sample matches the first biometric sample;
deriving, by at least one of the one or more computing devices, the unique identifier by applying the derivation process to the second biometric sample;
retrieving, by at least one of the one or more computing devices, the account information associated with the unique identifier based at least in part on the unique identifier and the index data structure; and
transmitting, by at least one of the one or more computing devices, the transaction information and the SIN corresponding to the retrieved account information to a computing device associated with the corresponding financial institution, wherein the computing device associated with the corresponding financial institution is configured to match the SIN to the account of the registrant and either approve or deny the attempted transaction.

2. The method of claim 1, wherein the biometric sample reader is configured to capture one or more of a fingerprint, hand print, face print, voice print, retinal image or other biometric sample.

3. The method of claim 1, wherein one or more of the unique identifier, the account information associated with the registrant, and the second biometric sample are encrypted and further comprising:
decrypting, by at least one of the one or more computing devices, one or more of the unique identifier, the account information associated with the registrant, or the second biometric sample.

4. The method of claim 1, wherein the biometric repository is configured to generate the SIN.

5. An apparatus for tokenless authorization of a transaction, the apparatus comprising:
one or more processors; and
one or more memories operatively coupled to at least one of the one or more processors and having instructions stored thereon that, when executed by at least one of the one or more processors, cause at least one of the one or more processors to:
receive a unique identifier from a registration device, the unique identifier being derived from a first biometric sample associated with a registrant using a derivation process, wherein the first biometric sample is captured by a biometric sample reader associated with the registration device and wherein the unique identifier is derived by the registration device by applying the derivation process;
receive account information associated with the registrant from the registration device, wherein the account information corresponds to an account of the registrant with an entity and generate a secure identification number (SIN), wherein the SIN is associated with the biometric sample of the registrant in a biometric repository;
store an association between the account information and the unique identifier in an index data structure;
receive a second biometric sample associated with the registrant from a biometric repository and transaction information corresponding to an attempted transaction of the registrant with a merchant, wherein the biometric repository is configured to receive the second biometric sample from a merchant computing device associated with the merchant and verify that the second biometric sample corresponds to a known biometric sample prior to transmitting the second biometric sample and wherein the second biometric sample matches the first biometric sample;
derive the unique identifier by applying the derivation process to the second biometric sample;
retrieve the account information associated with the unique identifier based at least in part on the unique identifier and the index data structure; and
transmit the transaction information and the SIN corresponding to the retrieved account information to a computing device associated with the corresponding entity, wherein the computing device associated with the corresponding entity is configured to match the SIN to the account of the registrant and either approve or deny the attempted transaction.

6. The apparatus of claim 5, wherein the biometric sample reader is configured to capture one or more of a fingerprint, hand print, face print, voice print or retinal image.

7. The apparatus of claim 5, wherein one or more of the unique identifier, the account information associated with the registrant, and the second biometric sample are encrypted, and wherein at least one of the one or more memories has further instructions stored thereon that, when executed by at least one of the one or more processors, cause at least one of the one or more processors to:
decrypt one or more of the unique identifier, the account information associated with the registrant, or the second biometric sample.

8. The apparatus of claim 5, wherein biometric repository is configured to generate the SIN.

9. At least one non-transitory computer-readable medium storing computer-readable instructions that, when executed by one or more computing devices, cause at least one of the one or more computing devices to:
receive a unique identifier from a registration device, the unique identifier being derived from a first biometric sample associated with a registrant using a derivation process, wherein the first biometric sample is captured by a biometric sample reader associated with the registration device and wherein the unique identifier is derived by the registration device by applying the derivation process;
receive account information associated with the registrant from the registration device and generate a secure identification number (SIN), wherein the account information corresponds to an account of the registrant with an entity and wherein the SIN is associated with the biometric sample of the registrant in a biometric repository;
store an association between the account information and the unique identifier in an index data structure;
receive a second biometric sample associated with the registrant from a biometric repository and transaction information corresponding to an attempted transaction of the registrant with a merchant, wherein the biometric repository is configured to receive the second biometric sample from a merchant computing device associated with the merchant and verify that the second biometric sample corresponds to a known biometric sample prior to transmitting the second biometric sample and wherein the second biometric sample matches the first biometric sample;
derive the unique identifier by applying the derivation process to the second biometric sample;
retrieve the account information associated with the unique identifier based at least in part on the unique identifier and the index data structure; and
transmit the transaction information and the SIN corresponding to the retrieved account information to a computing device associated with the corresponding entity, wherein the computing device associated with the corresponding entity is configured to match the SIN to the account of the registrant and either approve or deny the attempted transaction.

10. The at least one non-transitory computer-readable medium of claim 9, wherein the biometric sample reader is configured to capture one or more of a fingerprint, hand print, face print, voice print, retinal image or other biometric sample.

11. The at least one non-transitory computer-readable medium of claim 9, wherein one or more of the unique identifier, the account information associated with the registrant, and the second biometric sample are encrypted and further storing computer-readable instructions that, when executed by at least one of the one or more computing devices, cause at least one of the one or more computing devices to:
decrypt one or more of the unique identifier, the account information associated with the registrant, or the second biometric sample.

12. The at least one non-transitory computer-readable medium of claim 9, wherein biometric repository is configured to generate the SIN.
